(19) United States
(12) Patent Application Publication
(10) Pub. No.: US 2008/0158693 A1
(43) Pub. Date: Jul. 3, 2008

(54) FIXED-FOCUS LENS

(75) Inventors: Yi-Hao Kang, Hsinchu (TW); Hsin-Te Chen, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/845,247

(22) Filed: Aug. 27, 2007

(30) Foreign Application Priority Data
Jan. 2, 2007 (TW) 96100091

(51) Int. Cl. G02B 13/18

(52) U.S. Cl. 359/708

(57) ABSTRACT

A fixed-focus lens includes a first lens group and a second lens group. The two lens groups have positive refractive powers. The first lens group is composed of a first negative lens, a second negative lens, a third negative lens, a fourth positive lens and a fifth positive lens arranged in sequence from an object side to an image side. The first lens is an aspheric lens. The second lens group is composed of two cemented lens and a positive lens between them. The fixed-focus lens satisfies the following conditions: (1)5.0<F_{L45}/F<7.5; (2)3.5<F_{G2}/F<4.8; (3)F_{G2}/H>3.755, wherein F_{L45} is an effective focal length (EFL) from the fourth lens to the fifth lens, F_{G2} is an EFL of the second lens group, F is an EFL of the fixed-focus lens, and H is the maximum image height of the image side.

### CROSS-REFERENCE TO RELATED APPLICATION

This application claims the priority benefit of Taiwan application serial no. 96100091, filed Jan. 2, 2007. All disclosure of the Taiwan application is incorporated herein by reference.

### BACKGROUND OF THE INVENTION

1. Field of the Invention

The present invention relates to a lens, and more particularly to a fixed-focus lens.

2. Description of the Related Art

Please refer to FIG. 1, U.S. Pat. No. 6,542,316 discloses a conventional fixed-focus lens 100 used in a projection television. The conventional fixed-focus lens 100 includes a first lens group 110, a second lens group 120, and a third lens group 130 arranged in sequence from an object side to a light valve 50. The first lens group 110 includes six lenses 112, 114, 116, 117, 118, and 119. The second lens group 120 includes a lens 122. The third lens group 130 includes four lenses 132, 134, 136, and 138.

Because the conventional fixed-focus lens 100 includes more lenses, a cost of the conventional fixed-focus lens 100 is higher. Furthermore, the more lenses cause a longer length of the conventional fixed-focus lens 100, so that the projection television using the conventional fixed-focus lens 100 has a thicker thickness. To reduce the thickness of the conventional fixed-focus lens 100 enlarges an optical image aberration, and evenly occurs ghost images and so on to influence image quality.

### SUMMARY OF THE INVENTION

The present invention is providing a fixed-focus lens, which has advantages of a small cubage and a good image quality.

Other objections and advantages of the present invention are known from technological features disclosed by this disclosure.

To achieve one or part of the objections or other objections, the present invention provides a fixed-focus lens including a first lens group and a second lens group. The two lens groups have positive refractive powers. The first lens group is composed of a first lens, a second lens, a third lens, a fourth lens and a fifth lens arranged in sequence from an object side to an image side, and the refractive powers of the first to fifth lenses are negative, negative, negative, positive and positive respectively, and the first lens is an aspheric lens. The second lens group is arranged between the first lens group and the image side, the second lens group is composed of a sixth lens, a seventh lens, a eighth lens having a positive refractive power, a ninth lens and a tenth lens arranged in sequence from the object side to the image side. The sixth lens and the seventh lens construct a first cemented lens, and the ninth lens and the tenth lens construct a second cemented lens. In addition, F_{L45} is an effective focal length (EFL) from the fourth lens to the fifth lens, F_{G2} is an EFL of the second lens group, F is an EFL of the fixed-focus lens, H is a maximum image height of the image side, and 5.0<F_{L45}/F<7.5, 3.5<F_{G2}/F<4.8, F_{G2}/H>3.755.

Comparing with the conventional fixed-focus lens, the fixed-focus lens of the present invention includes less number of lenses, so that the fixed-focus lens of the present invention has a lower cost and a smaller cubage. Furthermore, the aberration of the fixed-focus lens of the present invention is effectively eliminated, so that good image quality is obtained.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout.

FIG. 1 is schematic view of a conventional fixed-focus lens.

FIG. 2 is a schematic view of a fixed-focus lens according to a first embodiment of the present invention.

FIGS. 3A, 3B and 3C are graphic diagrams showing optical imaging simulating results of the fixed-focus lens of FIG. 2.

FIG. 4 is a schematic view of a fixed-focus lens according to a second embodiment of the present invention.

FIGS. 5A, 5B and 5C are graphic diagrams showing optical imaging simulating results of the fixed-focus lens of FIG. 4.

FIG. 6 is a schematic view of a fixed-focus lens according to a third embodiment of the present invention.

FIGS. 7A, 7B and 7C are graphic diagrams showing optical imaging simulating results of the fixed-focus lens of FIG. 6.

FIG. 8 is a schematic view of a fixed-focus lens according to a fourth embodiment of the present invention.

### DESCRIPTION OF THE PREFERRED EMBODIMENTS

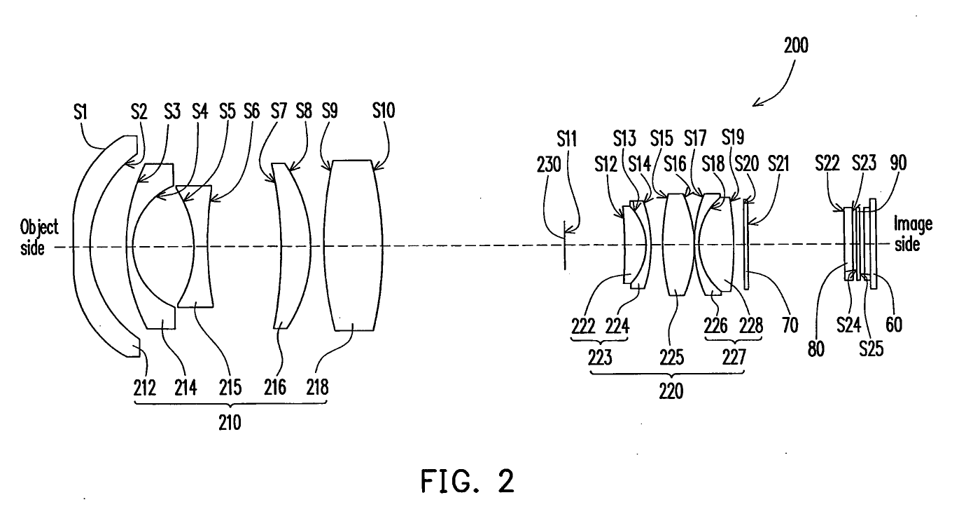

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive. Please refer to FIG. 2, a fixed-focus lens 200 of the embodiment includes a first lens group 210 and a second lens group 220, and the two lens groups 210 and 220 have positive refractive powers. The first lens group 210 is composed of a first lens 212, a second lens 214, a third lens 215, a fourth lens 216 and a fifth lens 218 arranged in sequence from an object side to an image side. The refractive powers of the first to fifth lenses 212, 214, 215, 216, and 218 are negative, negative, negative, positive and positive respectively. In this embodiment, the first lens 212 and the second lens 214 are meniscus lenses with convex surfaces (surfaces S1 and S3) facing the object side. The first lens 212 is an aspheric lens, and the convex surface and the concave surface (surface S2) of the first lens 212 are aspheric surfaces. The third lens 215 is a biconcave lens. The fourth lens 216 is exemplarily a meniscus lens with the convex surface (surface S8) facing the image side. The fifth lens 218 is a biconvex lens. The second lens 214, the third lens 215, the fourth lens 216, and the fifth lens 218 are spherical lenses.

The second lens group 220 is arranged between the first lens group 210 and the image side. The second lens group 220 is composed of a sixth lens 222, a seventh lens 224, a eighth lens 225, a ninth lens 226, and a tenth lens 228 arranged in sequence from the object side to the image side. The refractive powers of the sixth lens 222, the seventh lens 224, the eighth lens 225, the ninth lens 226, and the tenth lens 228 are exemplarily positive, negative, positive, negative, and positive respectively. The sixth lens 222 and the seventh lens 224 construct a first cemented lens 223. The ninth lens 226 and the tenth lens 228 construct a second cemented lens 227. The sixth lens 222 is a meniscus lens with the convex surface (surface S13) facing the image side. The seventh lens 224 is a meniscus lens with the convex surface (surface S14) facing the image side. The eighth lens 225 and the tenth lens 228 are biconvex lenses. The ninth lens 226 is a meniscus lens with the convex surface (surface S17) facing the object side. The sixth lens 222, the seventh lens 224, the eighth lens 225, the ninth lens 226, and the tenth lens 228 are spherical lenses.

The fixed-focus lens 200 satisfies the following conditions: (1)5.0<F_{L45}/F<7.5, (2)3.5<F_{G2}/F<4.8,(3)F_{G2}/H>3.755, wherein F_{L45} is an effective focal length (EFL) from the fourth lens to the fifth lens, F_{G2} is an EFL of the second lens group, F is an EFL of the fixed-focus lens, and H is a maximum image height of the image side. In general, an image-processing element 60 is arranged at the image side, and in this embodiment, the image-processing element 60 is exemplarily a light valve. The maximum image height H is an image height of an image imaged on the image-processing element 60 by an actual object. In addition, the fixed-focus lens 200 exemplarily further includes an aperture 230 arranged between the first lens group 210 and the second lens group 220.

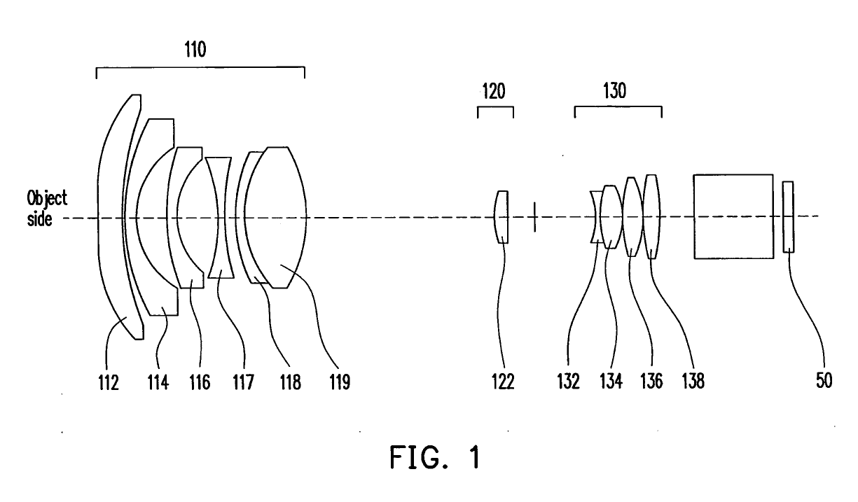

The fixed-focus lens 200 uses an aspheric lens (that is, the first lens 212) and nine spherical lenses (that is, the second lens to the tenth lens) to eliminate an image aberration. The aspheric lens facilitates to eliminate a distortion occurred by large field of view (FOV) over 90 degrees. The second lens group 220 eliminates a chromatic aberration and a spherical aberration. Comparing with the conventional fixed-focus lens 100 having eleven lenses (as shown in FIG. 1), the fixed-focus lens 200 of the present invention has the less number of lenses, so that the fixed-focus lens 200 reduces a cost and tolerance accumulation, and enhances product yield, and then reduces a manufacturing cost.

To further ensure the image quality, in this embodiment, the fixed-focus lens satisfies the following conditions: (1) 2.0<D_{G12}/F_{G2}<5.0, (2) 1.3<|F_{L67}/F_{L910}|<5.5, (3) 15<Vₚ−Vₙ<45, (4) 1.35<|R₁₅/R₁₆|<4.2. The D_{G12} is a distance from the first lens group 210 to the second lens group 220. The F_{L67} is an EFL of the first cemented lens 223, and the F_{L910} is an EFL of the second cemented lens 227. In addition, one of the first cemented lens 223 and the second cemented lens 227 is a positive refractive power, and another one is a negative refractive power. The Vₚ is an Abbe number of the cemented lens with positive refractive power, and the Vₙ is an Abbe number of the cemented lens with negative refractive power. The R15 is a radius of curvature of a surface (surface S15) facing the object side of the eighth lens 225, and the R16 is a radius of curvature of a surface (surface S16) facing the image side of the eighth lens 225.

The following content will indicate a first embodiment of the fixed-focus lens 200. Must pay attention is, data of the following table 1 and table 2 do not limit the present invention, after referring the present invention, any one skilled in the art can devise variations of reference numbers that are within the scope and spirit of the invention disclosed herein.

TABLE 1

| | Radius of | | | | |
|---|---|---|---|---|---|
| | curvature | Interval | Refractive | Abbe | |
| Surface | (mm) | (mm) | index | number | Note |
| S1 | 145.2828 | 5.8717 | 1.491 | 57.2 | First lens |
| S2 | 53.9941 | 15.1312 | | | |
| S3 | 75.2957 | 3.1291 | 1.805 | 25.5 | Second lens |
| S4 | 26.6127 | 26.3876 | | | |
| S5 | −38.0882 | 2.0049 | 1.621 | 60.3 | Third lens |
| S6 | 260.3931 | 24.5501 | | | |
| S7 | −113.1983 | 9.8644 | 1.575 | 41.5 | Fourth lens |
| S8 | −54.0286 | 0.6133 | | | |
| S9 | 201.6246 | 20.3181 | 1.541 | 47.2 | Fifth lens |
| S10 | −84.5378 | 109.8312 | | | |
| S11 | Indefinite | 18.0184 | | | Aperture |
| S12 | −111.4745 | 6.3224 | 1.487 | 70.4 | Sixth lens |
| S13 | −16.0638 | 2.9480 | 1.805 | 39.6 | Seventh lens |
| S14 | −43.8439 | 5.8102 | | | |
| S15 | 119.9789 | 7.8927 | 1.487 | 70.4 | Eighth lens |
| S16 | −34.8543 | 0.1196 | | | |
| S17 | 44.3126 | 1.4368 | 1.786 | 44.1 | Ninth lens |
| S18 | 22.3298 | 11.2158 | 1.487 | 70.4 | Tenth lens |
| S19 | −83.0216 | 1.7000 | | | |
| S20 | Indefinite | 0.7000 | 1.507 | 63.1 | Polarizer |
| S21 | Indefinite | 30.7953 | | | |
| S22 | Indefinite | 1.6500 | 1.507 | 63.1 | Contrast coupler |
| S23 | Indefinite | 0.7000 | | | |
| S24 | Indefinite | 0.7000 | 1.507 | 63.1 | Glass cover |
| S25 | Indefinite | 1.0000 | | | |

In the table 1, the radius of curvature refers to the radius of curvature of each surface, and the interval refers to the distance between two neighboring surfaces. For example, the interval of surface S1 is the distance between the surface S1 and the surface S2. The values of the thickness, refractive index and Abbe number corresponding to the various lenses in the note field refer to the interval, refractive index and Abbe number in the same row. In addition, in the table 1, the surfaces S1 and S2 are two surfaces of the first lens 212, and the surfaces S3 and S4 are two surfaces of the second lens 214, and the surfaces S5 and S6 are two surfaces of the third lens 215, and the surfaces S7 and S8 are two surfaces of the fourth lens 216, and the surfaces S9 and S10 are two surfaces of the fifth lens 218. The surface S11 is the aperture 230. The surface S12 is a surface of the sixth lens 222 facing the object side, and the surface S13 is a surface connecting the sixth lens 222 and the seventh lens 224, and the surface S14 is a surface of the seventh lens 224 facing the image side. The surfaces S15 and S16 are two surfaces of the eighth lens 225. The surface S17 is a surface of the ninth lens 226 facing the object side, and the surface S18 is a surface connecting the ninth lens 226 and the tenth lens 228, and the surface S19 is a surface of the tenth lens 228 facing the image side. The surfaces S20 and S21 are two surfaces of a polarizer 70. The surfaces S22 and S23 are two surfaces of a contrast coupler 80. The surfaces S24 and S25 are two surfaces of a glass cover 90 used for protecting an image-processing element 60. The interval in the row of the surface S25 is a distance from the surface S25 to the image-processing element 60.

Reference numbers relating to radius of curvatures, intervals, and so on of various lenses are referring to the table 1, and do not describe in detail herein. The surfaces S1 and S2 are aspheric, and satisfy the following formula:

$$Z = \frac{c {r}^{2}}{1 + \sqrt{1 - ( 1 + k ) {c}^{2} {r}^{2}}} + {A}_{1} {r}^{2} + {A}_{2} {r}^{4} + {A}_{3} {r}^{6} + {A}_{4} {r}^{8} + {A}_{5} {r}^{10} + …$$

Wherein the Z is a sag in the optical axis direction, and the c is a reciprocal of a radius of an osculating sphere, that is, a reciprocal of a radius of curvature (such as radius of curvature of the surface S1 or S2) near the optical axis. The k is a conic coefficient, and the r is an aspheric height, that is, a height from the center of the lens to an edge of the lens. The A₁, A₂, A₃, A₄, A₅ and so on are aspheric coefficients, and the A₁ is equal to 0. The following table 2 shows references of the surfaces S1 and S2.

TABLE 2

| Aspheric | conic | coefficient | coefficient | coefficient | coefficient |
|---|---|---|---|---|---|
| reference | coefficient k | A₂ | A₃ | A₄ | A₅ |
| S1 | −89.00191 | 9.061405E−06 | −1.492399E−09 | −5.507762E−13 | 3.353505E−16 |
| S2 | −0.5289708 | 5.306156E−06 | 1.141856E−08 | −1.314713E−11 | 3.442482E−15 |

In this embodiment, the f-number of the fixed-focus lens 200 is 2.417, and the maximum FOV is 91.3°. In addition, F=9.804 mm, F_{L45}=68.618 mm, F_{G2}=39.792 mm, H=10.243 mm, D_{G12}=134.172 mm. F_{L67}=−194.731 mm, F_{L910}=98.507, F_{L45}/F=6.999, D_{G12}/F_{G2}=3.372, |F_{L67}/F_{L910}|=1.977, F_{G2}/F=4.059, F_{G2}/H=3.885, 26.3<Vₚ−Vₙ<30.8.

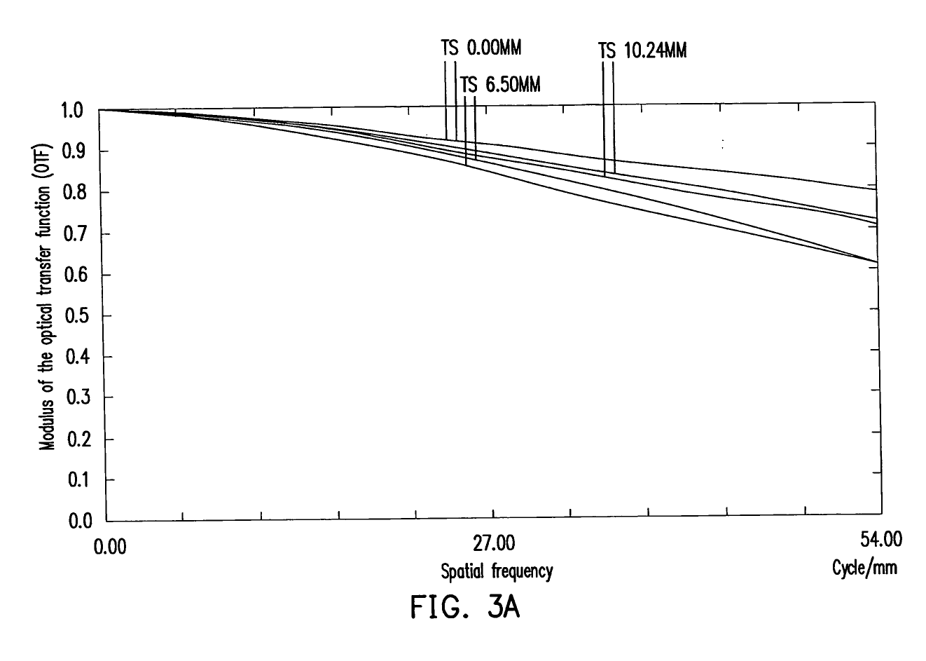

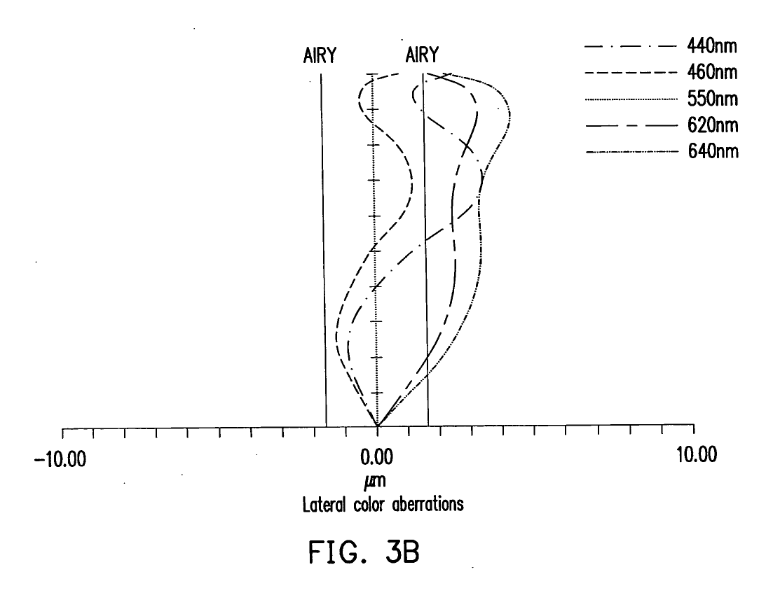

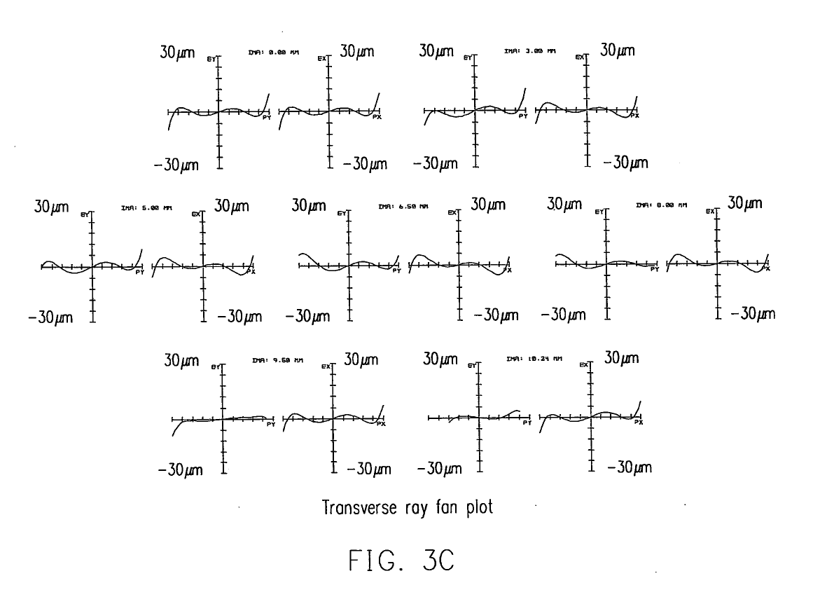

FIGS. 3A, 3B and 3C are graphic diagrams showing optical imaging simulating results of the fixed-focus lens of FIG. 2. Please refer FIGS. 3A, 3B and 3C, FIG. 3A is a graphic diagram showing the modulation transfer function (MTF) with the abscissa representing spatial frequency in cycles per millimeter (mm) and the ordinate representing modulus of the OTF. FIG. 3A is a simulating chart, wherein the related wavelength is selected from 440 nm to 640 nm. In addition, FIG. 3B shows lateral color aberrations of images, and the maximum field is 10.243 mm, and the referring wavelength is 550 nm. FIG. 3C is a transverse ray fan plot of images. Pictures shown by FIGS. 3A, 3B and 3C are within the standard scope, so that, comparing with the conventional fixed-focus lens, the fixed-focus lens 200 obtains good optical quality by using less number of lenses.

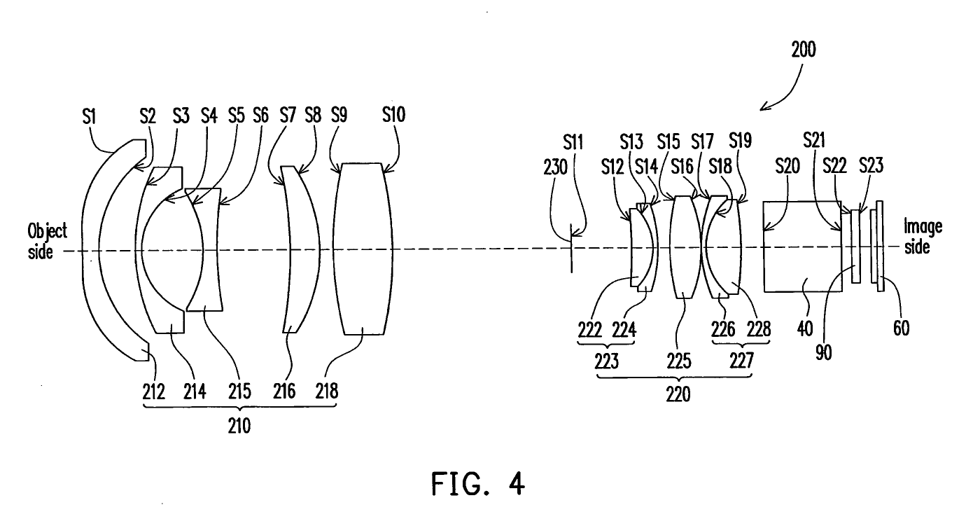

The following content indicates a second embodiment of the fixed-focus lens 200. Please refer to FIG. 4, tables 3 and 4.

TABLE 3

| | Radius of | | | | |
|---|---|---|---|---|---|
| | curvature | Interval | Refractive | Abbe | |
| Surface | (mm) | (mm) | index | number | Note |
| S1 | 70.2675 | 5.8133 | 1.491 | 57.2 | First lens |
| S2 | 33.9165 | 13.2428 | | | |
| S3 | 62.2700 | 3.3601 | 1.805 | 25.4 | Second lens |
| S4 | 25.4942 | 22.7612 | | | |
| S5 | −42.7191 | 3.0872 | 1.623 | 58.1 | Third lens |
| S6 | 102.5614 | 24.6611 | | | |
| S7 | −218.9725 | 12.7865 | 1.567 | 42.8 | Fourth lens |
| S8 | −61.0268 | 1.0087 | | | |
| S9 | 168.4864 | 19.9401 | 1.541 | 47.2 | Fifth lens |
| S10 | −89.3753 | 83.9428 | | | |
| S11 | Indefinite | 23.5953 | | | Aperture |
| S12 | −131.6132 | 8.0116 | 1.487 | 70.4 | Sixth lens |
| S13 | −18.6143 | 1.8389 | 1.805 | 39.6 | Seventh lens |
| S14 | −48.4620 | 1.3090 | | | |
| S15 | 79.8593 | 9.0900 | 1.487 | 70.4 | Eighth lens |
| S16 | −40.8563 | 0.1726 | | | |
| S17 | 48.6613 | 1.3603 | 1.789 | 42.8 | Ninth lens |
| S18 | 23.0180 | 16.8520 | 1.487 | 70.4 | Tenth lens |
| S19 | −74.4318 | 7.4897 | | | |
| S20 | Indefinite | 28.0000 | 1.517 | 64.2 | Total Internal |
| | | | | | reflective prism |
| S21 | Indefinite | 3.7500 | | | |
| S22 | Indefinite | 3.0000 | 1.487 | 70.4 | Glass cover |
| S23 | Indefinite | 0.4800 | | | |

TABLE 4

| Aspheric | conic | coefficient | coefficient | coefficient | coefficient |
|---|---|---|---|---|---|
| reference | coefficient k | A₂ | A₃ | A₄ | A₅ |
| S1 | −19.197910 | 7.500722E−06 | −1.592348E−09 | −1.789404E−13 | 2.400748E−16 |
| S2 | −0.829450 | 9.219816E−07 | 1.278201E−08 | −1.450110E−11 | 4.112173E−15 |

In the table 3, surfaces S1 to S19 are the same as the table 1. The surfaces S20 and S21 are two opposite surfaces of a total internal reflection (TIR) prism 40, and the surfaces S22 and S23 are two surfaces of the glass cover 90. The interval in the row of the surface S23 is a distance from the surface S23 to the image-processing element 60.

In this embodiment, the f-number of the fixed-focus lens 200 is 2.4, and the maximum FOV is 90.9°. In addition, F=10.905 mm, F_{L45}=64.233 mm, F_{G2}=42.342 mm, H=11.24 mm, D_{G12}=107.538 mm. F_{L67}=−259.217 mm, F_{L910}=105.271, F_{L45}/F=5.89, D_{G12}/F_{G2}=2.54, |F_{L67}/F_{L910}|=2.462, F_{G2}/F=3.883, F_{G2}/H=3.767, 27.6<Vₚ−Vₙ<30.8.

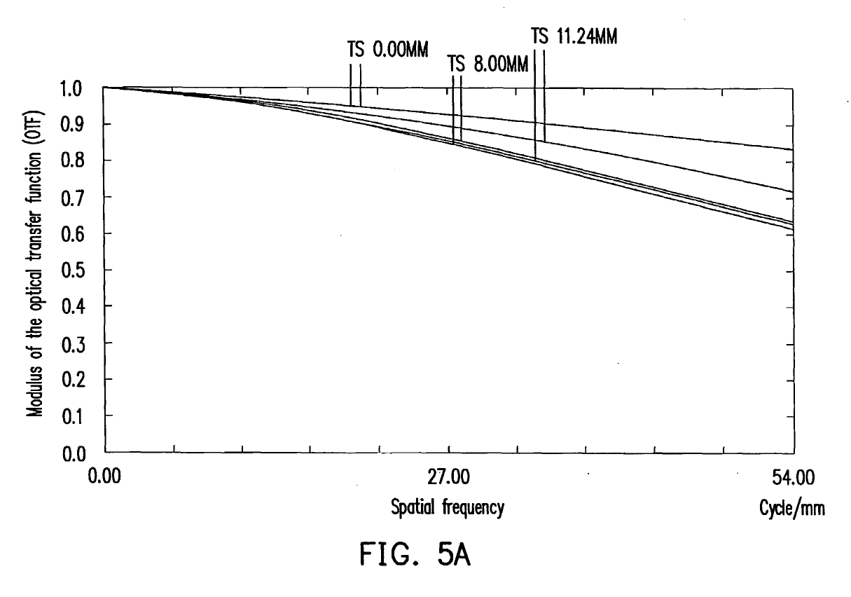

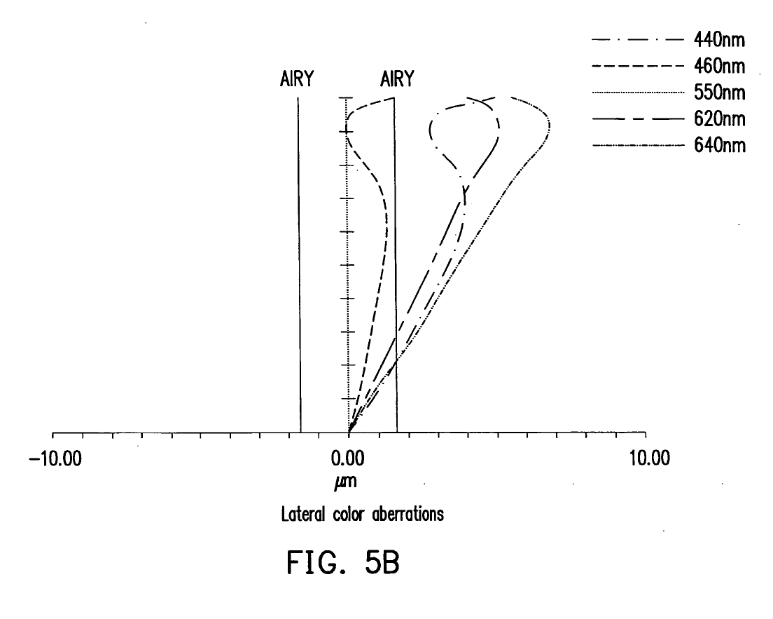

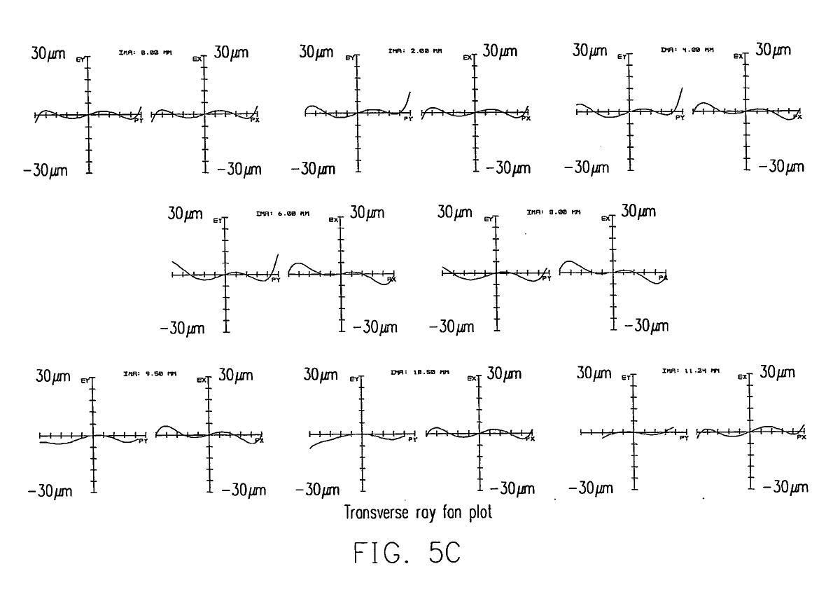

FIGS. 5A, 5B and 5C are graphic diagrams showing optical imaging simulating results of the fixed-focus lens of FIG. 4. Please refer FIGS. 5A, 5B and 5C, FIG. 5A is a graphic diagram showing the modulation transfer function (MTF) with the abscissa representing spatial frequency in cycles per millimeter (mm) and the ordinate representing modulus of the OTF. FIG. 5A is a simulating chart, wherein the related wavelength is selected from 440 nm to 640 nm. In addition, FIG. 5B shows lateral color aberrations of images, and the maximum field is 11.24 mm, and the referring wavelength is 550 nm. FIG. 5C is a transverse ray fan plot of images. Pictures shown by FIGS. 5A, 5B and 5C are within the standard scope, so that, comparing with the conventional fixed-focus lens, the fixed-focus lens 200 obtains good optical quality by using less number of lenses.

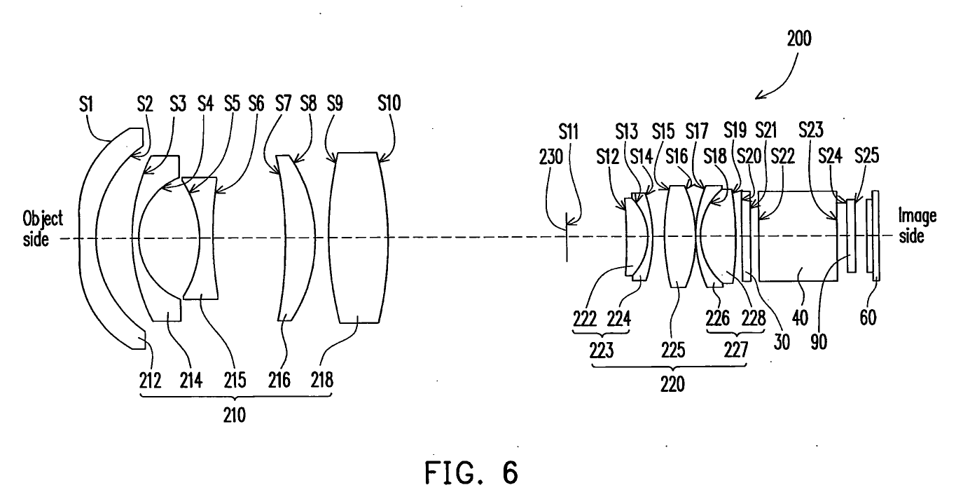

The following content indicates a third embodiment of the fixed-focus lens 200. Please refer to FIG. 6, tables 5 and 6.

TABLE 5

| | Radius of | | | | |
|---|---|---|---|---|---|
| | curvature | Interval | Refractive | Abbe | |
| Surface | (mm) | (mm) | index | number | Note |
| S1 | 175.8830 | 6.4082 | 1.492 | 57.4 | First lens |
| S2 | 56.8990 | 13.1701 | | | |
| S3 | 63.7223 | 2.1762 | 1.805 | 25.5 | Second lens |
| S4 | 23.9822 | 22.3554 | | | |
| S5 | −38.6568 | 4.7552 | 1.620 | 60.3 | Third lens |
| S6 | 140.6192 | 26.3108 | | | |
| S7 | −136.2515 | 11.0359 | 1.567 | 42.8 | Fourth lens |
| S8 | −54.1007 | 4.6385 | | | |
| S9 | 117.7371 | 22.0015 | 1.532 | 48.8 | Fifth lens |
| S10 | −110.8032 | 83.2192 | | | |
| S11 | Indefinite | 21.7693 | | | Aperture |
| S12 | −160.9378 | 7.9694 | 1.497 | 81.6 | Sixth lens |
| S13 | −19.0532 | 1.4931 | 1.805 | 39.6 | Seventh lens |
| S14 | −47.7297 | 4.4680 | | | |
| S15 | 77.2353 | 11.2869 | 1.487 | 70.4 | Eighth lens |
| S16 | −44.2104 | 0.1902 | | | |
| S17 | 46.5284 | 1.4959 | 1.789 | 42.8 | Ninth lens |
| S18 | 22.4564 | 12.5521 | 1.487 | 70.4 | Tenth lens |
| S19 | −87.1335 | 1.9606 | | | |
| S20 | Indefinite | 3.0000 | 1.523 | 58.6 | |
| S21 | Indefinite | 3.0000 | | | |
| S22 | Indefinite | 28.0000 | 1.517 | 64.2 | Total Internal |
| | | | | | reflective |
| | | | | | prism |
| S23 | Indefinite | 3.7500 | | | |
| S24 | Indefinite | 3.0000 | 1.487 | 70.4 | Glass cover |
| S25 | Indefinite | 0.4800 | | | |

TABLE 6

| Aspheric | conic | coefficient | coefficient | coefficient | coefficient |
|---|---|---|---|---|---|
| reference | coefficient k | A₂ | A₃ | A₄ | A₅ |
| S1 | −163.3925 | 8.756840E−06 | −1.598966E−09 | −1.736070E−13 | 2.737983E−16 |
| S2 | −0.5796957 | 4.181319E−06 | 1.225761E−08 | −1.448743E−11 | 4.066283E−15 |

In the table 5, surfaces S1 to S19 are the same as the table 1. The surfaces S20 and S21 are two surfaces of a smooth image element 30, and the surfaces S22 and S23 are two opposite surfaces of a total internal reflection (TIR) prism 40, and the surfaces S24 and S25 are two surfaces of the glass cover 90. The interval in the row of the surface S25 is a distance from the surface S25 to the image-processing element 60.

In this embodiment, the f-number of the fixed-focus lens 200 is 2.4, and the maximum FOV is 90.9°. In addition, F=10.413 mm, F_{L45}=65.653 mm, F_{G2}=41.565 mm, H=10.706 mm, D_{G12}=104.988 mm. F_{L67}=−462.489 mm, FL₉₁₀=110.426, F_{L45}/F=6.3, D_{G12}/F_{G2}=2.526, |F_{L67}/F_{L910}|=4.188, F_{G2}/F=3.99, F_{G2}/H=3.88, 27.6<Vₚ−Vₙ<42.

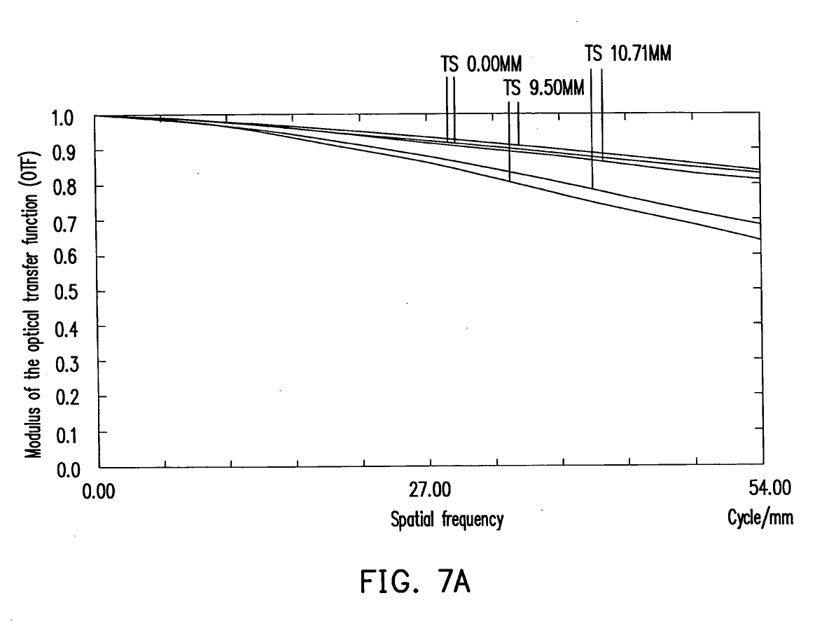

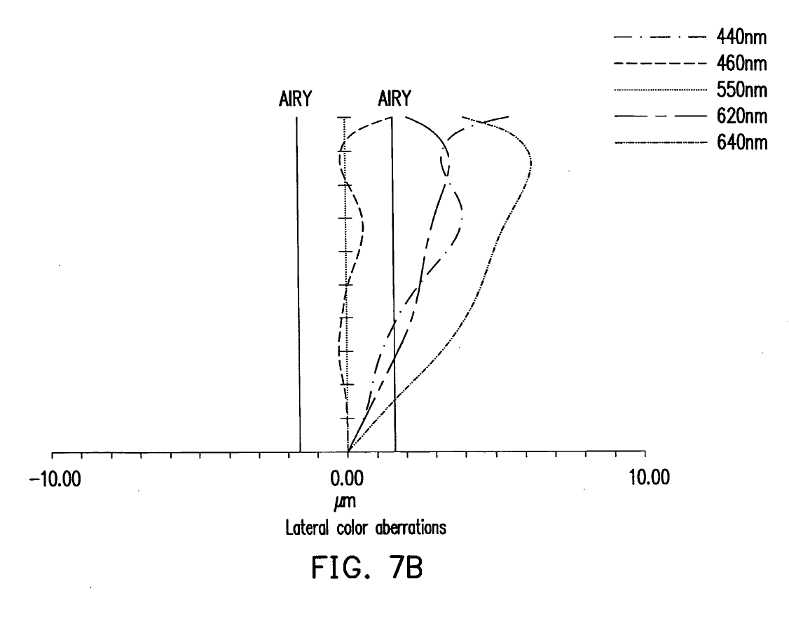

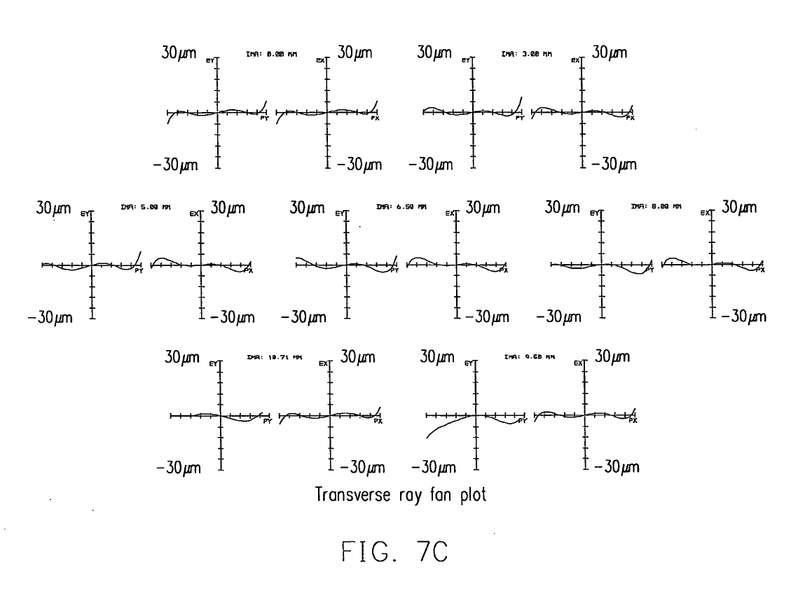

FIGS. 7A, 7B and 7C are graphic diagrams showing optical imaging simulating results of the fixed-focus lens of FIG. 6. Please refer FIGS. 7A, 7B and 7C, FIG. 7A is a graphic diagram showing the modulation transfer function (MTF) with the abscissa representing spatial frequency in cycles per millimeter (mm) and the ordinate representing modulus of the OTF. FIG. 7A is a simulating chart, wherein the related wavelength is selected from 430 nm to 670 nm. In addition, FIG. 7B shows lateral color aberrations of images, and the maximum field is 10.7061 mm, and the referring wavelength is 550 nm. FIG. 7C is a transverse ray fan plot of images. Pictures shown by FIGS. 7A, 7B and 7C are within the standard scope, so that, comparing with the conventional fixed-focus lens, the fixed-focus lens 200 obtains good optical quality by using less number of lenses.

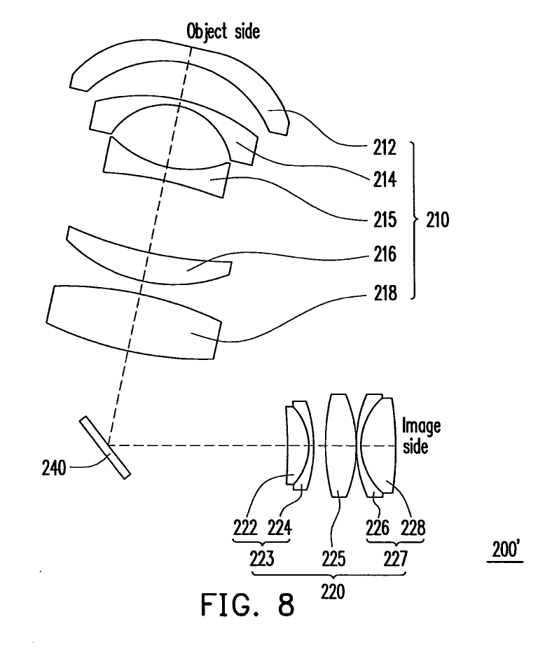

Please refer to FIG. 8, a fixed-focus lens 200′ of this embodiment is similar to the fixed-focus lens 200 shown in FIG. 2. The difference is that the fixed-focus lens 200′ further includes a reflective element 240 arranged between the first lens group 210 and the second lens group 220. In other words, the fixed-focus lens 200′ is an L type lens. Because the fixed-focus lens 200′ has a shorter length, a projection television using the fixed-focus lens 200′ obtains a thinner thickness.

In a word, the fixed-focus lens of the present invention at least has the following advantages:

1. Comparing with the conventional fixed-focus lens 100 having eleven lenses, the fixed-focus lenses 200 and 200′ of the present invention have less number of lenses, so that the fixed-focus lens 200 and 200′ reduces a cost and tolerance accumulation, and enhances product yield, and then reduces a manufacturing cost.

2. The aberration of the fixed-focus lens of the present invention is effectively eliminated, so that good image quality is obtained.

3. The fixed-focus lens of the present invention is a L type lens, so that the fixed-focus lens of the present invention has a shorter length, and further, a projection television using the fixed-focus lens 200′ obtains a thinner thickness.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fixed-focus lens, comprising:
a first lens group having a positive refractive power, the first lens group composed of a first lens, a second lens, a third lens, a fourth lens, and a fifth lens arranged in sequence from an object side to an image side, wherein the refractive powers of the first to fifth lenses are negative, negative, negative, positive and positive respectively, and the first lens is an aspheric lens; and
a second lens group having a positive refractive power and arranged between the first lens group and the image side, the second lens group composed of a sixth lens, a seventh lens, a eighth lens having a positive refractive power, a ninth lens, and a tenth lens arranged in sequence from the object side to the image side, wherein the sixth lens and the seventh lens construct a first cemented lens, and the ninth lens and the tenth lens construct a second cemented lens;
wherein F_{L45} is an effective focal length (EFL) from the fourth lens to the fifth lens, F_{G2} is an EFL of the second lens group, F is an EFL of the fixed-focus lens, H is a maximum image height of the image side, and 5.0<F_{L45}/F<7.5, 3.5<F_{G2}/F<4.8, F_{G2}/H>3.755.

2. The fixed-focus lens as claimed in claim 1, further comprising an aperture arranged between the first lens group and the second lens group.

3. The fixed-focus lens as claimed in claim 1, further comprising a reflective element arranged between the first lens group and the second lens group.

4. The fixed-focus lens as claimed in claim 1, wherein D_{G12} is a distance from the first lens group to the second lens group, and 2.0<D_{G12}/F_{G2}<5.0.

5. The fixed-focus lens as claimed in claim 1, wherein F_{L67} is an EFL of the first cemented lens, F_{L910} is an FEL of the second cemented lens, and 1.3<|F_{L67}/F_{L910}|<5.5.

6. The fixed-focus lens as claimed in claim 5, wherein one of the first cemented lens and the second cemented lens is a positive refractive power and another one is a negative refractive power, and Vₚ is an Abbe number of the cemented lens with positive refractive power, Vₙ is an Abbe number of the cemented lens with negative refractive power, and 15<Vₚ−Vₙ<45.

7. The fixed-focus lens as claimed in claim 1, wherein R₁₅ is a radius of curvature of a surface facing the object side of the eighth lens, R₁₆ is a radius of curvature of a surface facing the image side of the eighth lens, and 1.35<|R₁₅/R₁₆|<4.2.

8. The fixed-focus lens as claimed in claim 1, wherein the refractive powers of the sixth lens, the seventh lens, the ninth lens and the tenth lens are positive, negative, negative, and positive respectively.

9. The fixed-focus lens as claimed in claim 1, wherein the first lens and the second lens are meniscus lenses with convex surfaces facing the object side, and the convex surface and the concave surface of the first lens are aspheric, the third lens is a biconcave lens, the fourth lens is a meniscus lens with a convex surface facing the image side, and the fifth lens is a biconvex lens.

10. The fixed-focus lens as claimed in claim 1, wherein the sixth lens is a meniscus lens with a convex surface facing the image side, the seventh lens is a meniscus lens with a convex surface facing the image side, the eighth lens and the tenth lens are biconvex lenses, and the ninth lens is a meniscus lens with a convex surface facing the object side.

11. The fixed-focus lens as claimed in claim 1, wherein the second lens, the third lens, the fourth lens, the fifth lens, the sixth lens, the seventh lens, the eighth lens, the ninth lens and the tenth lens are spherical lenses.
